(19) United States
(12) Patent Application Publication
(10) Pub. No.: US 2016/0037381 A1
(43) Pub. Date: Feb. 4, 2016

(54) COMMUNICATION TERMINAL FOR A VEHICLE AND METHOD FOR SETTING A COMMUNICATION CONFIGURATION THEREOF

(71) Applicant: HYUNDAI MOBIS CO., LTD., Seoul (KR)

(72) Inventors: Jong In JUNG, Yongin-si (KR); Doo Yeon LEE, Yongin-si (KR)

(21) Appl. No.: 14/807,758

(22) Filed: Jul. 23, 2015

(30) Foreign Application Priority Data
Aug. 1, 2014 (KR) 10-2014-0098946

(51) Int. Cl. H04W 28/02; H04W 4/00; H04L 12/801; H04W 16/22

(52) U.S. Cl. CPC H04W 28/0284; H04W 16/225; H04W 4/008; H04L 47/12; H04W 88/02

(57) ABSTRACT

Disclosed herein is a communication terminal for a vehicle and a method for setting the communication configuration of the communication terminal for a vehicle, comprising: a first converting unit for receiving and decoding encoded detail traffic information from an on-board equipment for receiving traffic information from a road-side equipment (RSE) and extracting detail traffic information for the traffic information; a communication control unit for receiving the decoded detail traffic information from the first converting unit and setting a communication configuration to correspond to the detail traffic information referring to a data storing unit; and a first communication unit for communicating with the communication configuration set in the communication control unit.

### CROSS-REFERENCES TO RELATED APPLICATIONS

The present application claims priority to Korean application number 10-2014-0098946, filed on Aug. 1, 2014, which is incorporated by reference in its entirety.

### BACKGROUND

1. Field

The present disclosure relates to a communication terminal for a vehicle and a method for setting a communication configuration thereof.

2. Discussion of the Related Technology

In general, if a plurality of terminals sharing one communication line are trying to communicate in a specific area (communication area), it is possible that a line collision (congestion) occurs and thus the communication efficiency can be greatly reduced. So, if this line collision occurs, as each node tries again to reconnect to occupy the communication line and then the line collision does again occur repeatedly, the congestion can be more increased. Accordingly, to reduce this congestion the communication methods have been developed.

The related technology is disclosed in Korean Patent Laid-open Publication No. 10-2014-0038180 published on Mar. 28, 2014 and entitled “APPARATUS AND METHOD FOR WARNING A VEHICLE APPROACHING AN INTERSECTION USING V2X”.

### SUMMARY

In view of the above, embodiments of the present invention has been made to meet the above-mentioned needs, and thus embodiments of the present invention are directed to a communication terminal for a vehicle and a method for setting a communication configuration thereof which can recognize surrounding circumstances using a traffic information system based on a Dedicated Short Range Communication (DSRC), and adjust a communication configuration of the communication terminal based on the recognized information to improve efficiency of its communication performance.

A communication terminal for a vehicle according to an embodiment of the present invention may include: a first converting unit for receiving and decoding encoded detail traffic information from an on-board equipment, the on-board equipment receiving traffic information from a road-side equipment (RSE) and extracting detail traffic information for the traffic information; a communication control unit for receiving the decoded detail traffic information from the first converting unit and setting a communication configuration corresponding to the detail traffic information referring to a data storing unit; and a first communication unit for communicating under the communication configuration set by the communication control unit.

According to another embodiment, the on-board equipment may include a second communication unit for receiving the traffic information from the road-side equipment via a dedicated short range communication (DSRC); a processing unit for receiving the traffic information from the second communication unit and extracting the detail traffic information from the traffic information; and a second converting unit for encoding detail traffic information extracted by the processing unit and transmitting the encoded detail traffic information.

According to another embodiment, the processing unit may extract the detail traffic information including a node link, a traffic volume, a density and a speed from the traffic information received from the second communication unit.

According to another embodiment, the communication terminal may further include a data storing unit where the setting values are stored which define access trying windows (CW) and transmit powers (Tx Power) corresponding to the traffic congestion steps classified based on a traffic volume, a density and a speed per a node link.

According to another embodiment, the communication control unit may set the communication configuration to a setting value according to the traffic congestion step corresponding to the detail traffic information.

A method of setting a communication configuration of a communication terminal for a vehicle according to another embodiment of the present invention may include deciding, by an on-board equipment, whether a vehicle enters a dedicated short range communication (DSRC) area; when as a result of deciding the vehicle entered the dedicated short range communication area, receiving, by the on-board equipment, traffic information from a road-side equipment via the dedicated short range communication; receiving, by the on-board equipment, the traffic information and extracting detail traffic information from the traffic information; encoding, by the on-board equipment, the extracted detail traffic information, and transmitting the encoded detail traffic information to a first converting unit; receiving and decoding, by the first converting unit, the encoded detail traffic information; and receiving, by a communication control unit, the decoded detail traffic information and setting the communication configuration to correspond to the detail traffic information referring to a data storing unit.

According to another embodiment, extracting the detail traffic information may include extracting the detail traffic information comprising a node link, a traffic volume, a density and a speed from the traffic information received from a second communication unit of the on-board equipment.

According to another embodiment, setting the communication configuration may include setting the communication configuration to a setting value according to a traffic congestion step corresponding to the detail traffic information referring to the data storing unit where the setting values are stored which define access trying windows (CW) and transmit powers (Tx Power) corresponding to the traffic congestion steps classified based on a traffic volume, a density and a speed per a node link.

A communication terminal for a vehicle and a method for setting a communication configuration thereof according to embodiments of the present invention can recognize surrounding circumstances using a traffic information system based on a Dedicated Short Range Communication (DSRC), and adjust a communication configuration of the communication terminal based on the recognized information to improve efficiency of its communication performance.

### BRIEF DESCRIPTION OF THE DRAWINGS

FIG. 1 is a block diagram for illustrating a communication terminal for a vehicle according to an embodiment of the present invention.

FIG. 2 is a diagram for explaining a use environment of the communication terminal for a vehicle according to an embodiment of the present invention.

FIG. 3 is a flow chart for illustrating a method for setting a communication configuration of the communication terminal for a vehicle according to an embodiment of the present invention.

### DESCRIPTION OF EMBODIMENTS

Embodiments of the invention will hereinafter be described in detail with reference to the accompanying drawings. It should be noted that the drawings are not to precise scale and may be exaggerated in thickness of lines or sizes of components for descriptive convenience and clarity only.

Furthermore, the terms as used herein are defined by taking functions of the invention into account and can be changed according to the custom or intention of users or operators. Therefore, definition of the terms should be made according to the overall disclosures set forth herein.

To reduce this congestion the following communication methods may be used. Firstly, in a CSMA(Carrier Sense Multiple Access)/CA(Collision Avoidance) which is a communication method used in a Wireless LAN (WLAN) or a communication for a vehicle (WAVE), an On-Board Equipment (OBE) desired to communicate or Road-Side Equipment (RSE) transmits for a first time RTS (Request To

Send) packets. Then a road-side equipment or an on-board equipment which received RTS packets responses with CTS (Clear To Send) packets, wherein only the on-board equipment which received CTS packets can communicate in this area and remaining terminals will wait.

Secondly, in a CSMA/CD (Collision Detection) which is a communication method used in a wired Ethernet (LAN), a road-side equipment desired to communicate or an on-board equipment can check a communication status in a communication area. If there is no signal being detected, it can add its own address and destination address to a signal and then broadcast (Broadcast) the signal. At that time, if the collision occurs, it waits for a random time and then retransmits the signal.

Thirdly, in an ALOHA (Additive Links Online Hawaii Area) which is a communication method used in a Master/Slave manner, an on-board equipment can communicate in a slot allocated by a road-side equipment. The road-side equipment can broadcast periodically and the on-board equipment can try to connect in a specific period. If it is successful that the on-board equipment tries to connect, the on-board equipment can communicate in a next slot allocated for a communication. If the collision occurs at this time, the on-board equipment avoids the collision by exponentially increasing a slot allocated for a communication. This method is used mainly as a slotted ALOHA manner, wherein if the collision occurs in a slot allocated for a communication, the method retries to connect after a predetermined period of time.

However, if the communication is tried via the same line (channel) and then the collision occurs, as these communication methods retry the communication after a predetermined period of time (exponential increase, random time), the above-mentioned communication methods have the disadvantages that the communication efficiency can be greatly reduced, as a period of time to be retried to connect will increased by the numbers of line collisions (congestion) when many communication apparatuses try to communicate in a specific area.

Also, a traffic information system based on a Dedicated Short Range Communication (DSRC) provides an intelligent transportation system service, wherein the traffic information system based on the dedicated short range communication can provides the services such as retrieving the road-side circumstances via base stations positioned at the sides of the road, collecting and providing traffic information, and delivering the traffic signals.

Accordingly, the traffic information system based on the dedicated short range communication may be established in the national freeway and the local roads nationwide, and can provide traffic information such as a traffic volume and a density which are provided fundamentally, to the on-board equipment via communications between vehicles (Vehicle to Everything or Vehicle to X, which is referred to as ‘V2X’ in the following), so that the traffic information provided can be utilized variously.

Here, the term X in the V2X refers to everything, i.e., Infra/Vehicle/Nomadic/ . . . and the like, and the V2X represents all the type of communication schemes which can be possibly applied to the vehicle, or means specific communications techniques for implementing a general term ‘Connected Vehicle’ or ‘Networked Vehicle’.

And, V2X communication can largely classified into three categories: communication between a vehicle and an infrastructure (Vehicle-to-Infrastructure: V2I), communication between a vehicle and a vehicle (Vehicle-to-Vehicle: V2V), and communication between a vehicle and a mobile device (Vehicle-to-Nomadic device: V2N), and recently it is expected that other types of communication categories can be added.

Accordingly, as the V2X may be applied to the vehicle to be developed later, it is needed a technique for implementing an optimal communication environment by providing a suitable V2X communication environment according to a surrounding circumstances as it is expected that the communication congestion can be more and more increasingly.

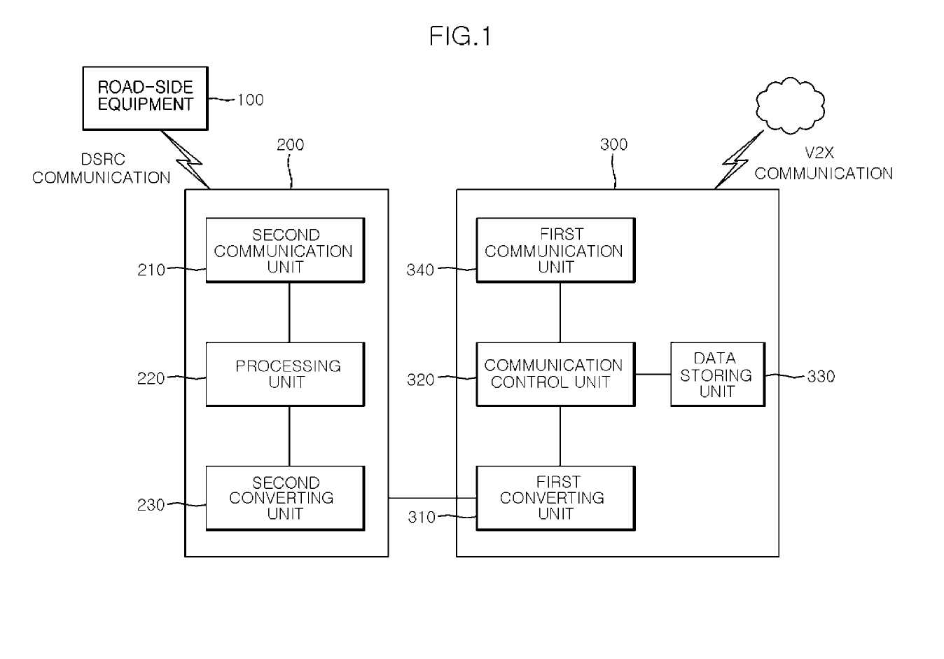

FIG. 1 is a block diagram for illustrating a communication terminal for a vehicle according to an embodiment of the present invention.

As shown in FIG. 1, a communication terminal 300 for a vehicle according to an embodiment of the present invention may comprise a first converting unit 310, a communication control unit 320, a data storing unit 330 and a first communication unit 340.

The first converting unit 310 may receive and decode the encoded detail traffic information from an on-board equipment 200 which receives traffic information from a Road-Side Equipment (RSE) 100 and extracts detail traffic information from the traffic information.

Here, the Road-Side Equipment (RSE) 100 is in communication with a traffic information system and broadcasts the traffic information periodically via a Dedicated Short Range Communication (DSRC).

In particular, the Road-Side Equipment broadcasts the traffic information periodically using a broadcast kernel (Broadcast-KE), wherein the traffic information which is broadcast may comprise traffic flow information, traffic control information, sudden incident information, road condition information, and weather information and the like.

In more particular, the traffic flow information may comprise road position information (LinkID), speed information (Speed Rate), travel time information (TravelTime) and the like, the traffic control information may comprise event position information (Location Information), event type (EventTypeCode) and the like, the sudden incident information may comprise sudden incident type (IncidentTypeCode), sudden incident start point (BeginID), sudden incident end point (EndID) and the like, the road condition information may comprise road position information (LinkID), road surface condition information (SurfaceConditionCode) and the like, the weather information may comprise a weather report (wind speed, humidity, precipitation ratio and the like), weather forecast (precipitation probability, wind speed and the like), weather alert (region, alarm type, etc.) and the like.

Also, the on-board equipment 200 may comprises a second communication unit 210, a processing unit 220, and a second converting unit 230, and may receive the traffic information from the road-side equipment 100 positioned adjacent to the vehicle 400 via the Dedicated Short Range Communication (DSRC).

In other words, when the vehicle 400 provided with the on-board equipment 200 enters a communication area of the road-side equipment (DSRC-RSE) 100 connected to a Freeway Traffic Management System (FTMS) infrastructure which is already established, the on-board equipment receives the traffic information broadcast from the road-side equipment 100, sense a traffic volume (vehicle traffic), a density and a speed, etc. over the area in which the vehicle 400 is positioned, and then process the sensed traffic information.

In particular, the second communication unit 210 of the on-board equipment 200 may receive data from the road-side equipment 100 via the dedicated short range communication, and in more particular, the second communication unit decides whether the received data relates to the traffic information via AID (Application ID) of the data, and accept the data if the received data relates to the traffic information.

And, the processing unit 220 of the on-board equipment 200 extracts detail traffic information from the traffic information received from the second communication unit 210, and extracts the detail traffic information including a node link, a traffic volume, a density, and a speed from the received traffic information.

In more particular, the detail traffic information may include a message creating time (Message Creative Generalized Time, MCGT), a node link (LinkID) (road information, position information), speed information (SpeedRate) of the node link, traffic volume information (VolumeRate) of the node link, and density information (DensityRate) of the node link and the like among the traffic flow information broadcast from the road-side equipment 100.

The second converting unit 230 of the on-board equipment 200 encodes the detail traffic information extracted by the processing unit 220 and sends the encoded detail traffic information.

In other words, the detail traffic information extracted by the processing unit 220 can be encoded and sent in a suitable form (e.g., RS-232) by the interface between the on-board equipment 200 and the communication terminal 300 for a vehicle.

The communication control unit 320 receives the decoded detail traffic information from the first converting unit 310, and set a communication configuration to correspond to the detail traffic information received referring to a data storing unit 330.

To this end, the communication control unit 320 extracts a traffic congestion step corresponding to the detail traffic information referring to the data storing unit 330 where the setting values are stored which define access trying windows (Contention Window, CW) and transmit powers (Tx Power) corresponding to the traffic congestion steps classified based on a traffic volume, a density and a speed per a node link, and sets the communication configuration to a setting value corresponding to the extracted traffic congestion step.

If there is no traffic congestion step corresponding to the detail traffic information received, the communication configuration can be set to a default value.

Here, the communication terminal 300 may comprise not only a communication (V2X) apparatus for a vehicle and but also the dedicated short range communication (DSRC) system.

The data storing unit 330 may store the traffic congestion steps classified based on a traffic volume, a density and a speed per a node link, and the setting values defining the access trying windows (CW) and the transmit powers (Tx Power) corresponding to the traffic congestion steps.

To this end, the setting values corresponding to the traffic congestion steps which are stored in the data storing unit 330 can be defined as follows:

At first, the traffic congestion steps can be classified based on a traffic volume, a density, and a speed stepwise per a node link. For example, a traffic volume for a national road can be classified into 1 step (300 vehicles/hour or less), 2 step (500 vehicles/hour or less), 3 step (700 vehicles/hour or less), 4 step (900 vehicles/hour or less), 5 step (1100 vehicles/hour or more), and 6 step (1300 vehicles/hour or more), based on 700 vehicles/hour (referring to a traffic volume average, 2013), and classified into 1 step (100 vehicles or less), 2 step (200 vehicles or less), and 3 step (400 vehicles or more), assuming that for the national road with a 4-lane round-trip of 500 m intervals where a speed limit is 80 km/h, a density is up to 400 vehicles, and the speeds in these conditions are classified into 1 step (35 km/h or less), 2 step (55 km/h or less), and 3 step (75 km/h or more).

The setting values corresponding to these traffic congestion steps can be defined as follows:
setting value: CW=7, Tx Power=level 6, corresponding to traffic volume 1 step, density 1 step, speed 3 step;
setting value: CW=15, Tx Power=level 5, corresponding to traffic volume 2 step, density 1 step, speed 2, 3 step;
setting value: CW=31, Tx Power=level 4, corresponding to traffic volume 3 step, density 2 step, speed 2, 3 step;
setting value: CW=63, Tx Power=level 3, corresponding to traffic volume 4 step, density 2 step, speed 2 step;
setting value: CW=127, Tx Power=level 2, corresponding to traffic volume 5 step, density 3 step, speed 1, 2 step; and
setting value: CW=255, Tx Power=level 1, corresponding to traffic volume 6 step, density 3 step, speed 1, 2 step.

The above values are provided as only an example to aid the understanding of the present invention, and are not intended to limit the traffic congestion steps and setting values of the present invention to the above-mentioned numerical values.

The first communication unit 340 may adjust the communication configuration as set in the communication control unit 320 and then perform the communication.

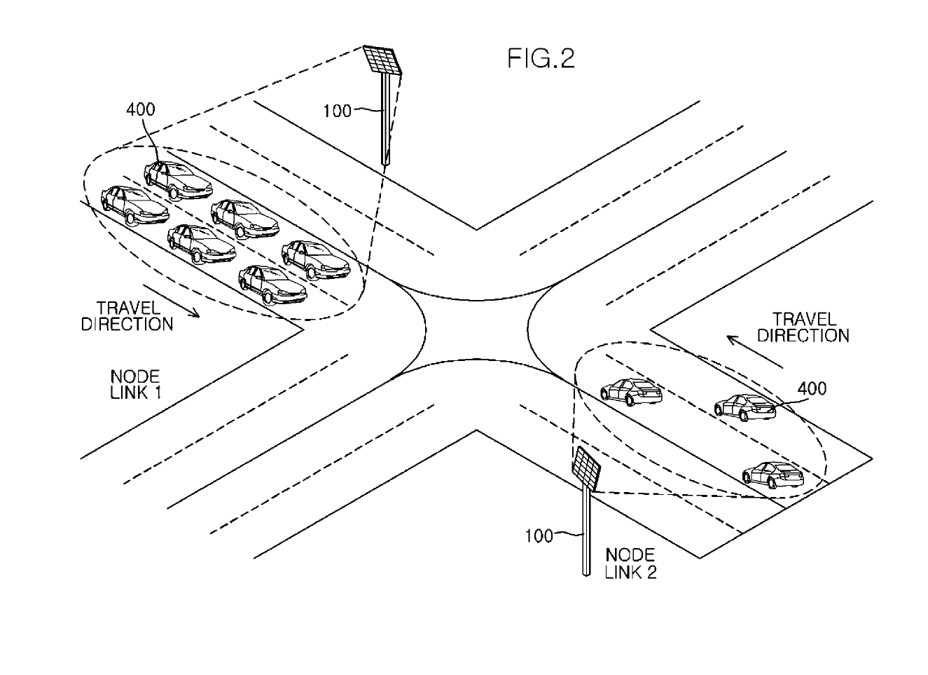

FIG. 2 is a diagram for explaining a use environment of the communication terminal for a vehicle according to an embodiment of the present invention.

As shown in FIG. 2, the communication terminal 300 may receive the traffic information from the road-side equipment 100, and recognize the surrounding circumstances that the traffic volume (vehicle traffic) and density are high in the area corresponding to a node link 1, and low in the area corresponding to a node link 2. In other words, the road-side equipment 100 send the traffic information periodically, and the on-board equipment 200 and the communication terminal 300 provided in the vehicle 400 which received the traffic information may decide the traffic volume, density and speed from the traffic information received from the node link (position). Thus decided result is compared with the traffic congestion steps which is previously stored in the data storing unit 330, and when the result of comparing is matched with any of the traffic congestion steps the communication configuration is set to a setting value corresponding to the matched traffic congestion step.

As discussed above, the communication terminal for a vehicle according to an embodiment of the present invention can recognize surrounding circumstances using the traffic information system based on a Dedicated Short Range Communication (DSRC), and adjust the communication configuration of the communication terminal based on the recognized information to improve efficiency of its communication performance.

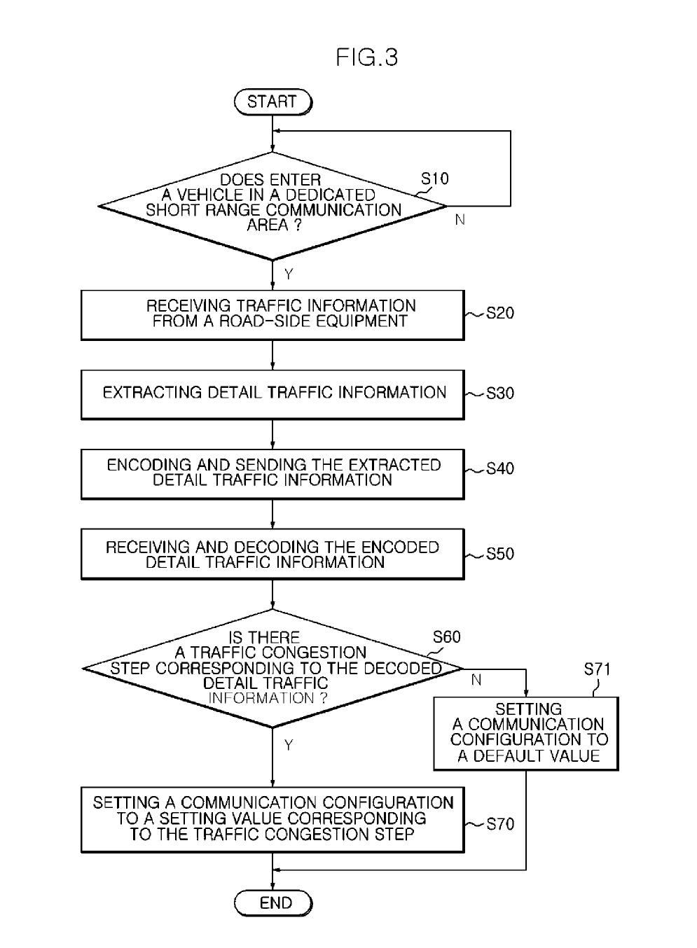

FIG. 3 is a flow chart for illustrating a method for setting a communication configuration of the communication terminal for a vehicle according to an embodiment of the present invention.

First of all, the second communication unit 210 of the on-board equipment 200 decides whether the vehicle 400 entered the Dedicated Short Range Communication (DSRC) area (S10).

At this time, when the vehicle 400 provided with the on-board equipment 200 enters a communication area of the road-side equipment (DSRC-RSE) 100 connected to the freeway traffic management system (FTMS) infrastructure which is already established, the on-board equipment can receive the traffic information broadcast by the road-side equipment 100, sense a traffic volume (vehicle traffic), a density and a speed, etc. over the area in which the vehicle 400 is positioned, and then process the sensed traffic information.

As a result of deciding in step S10, when a vehicle 400 provided with the on-board equipment 200 entered the dedicated short range communication area, the second communication unit 210 of the on-board equipment 200 can receive the traffic information from the road-side equipment (RSE) 100 via the dedicated short range communication (S20).

In particular, the second communication unit 210 of the on-board equipment 200 can decide whether the received data relates to the traffic information via AID (Application ID) of the data, and accept the data if the received data relates to the traffic information.

Here, the Road-Side Equipment (RSE) 100 is in communication with a traffic information system and broadcasts the traffic information periodically via a Dedicated Short Range Communication (DSRC), and in particular, the Road-Side Equipment broadcasts the traffic information periodically using a broadcast kernel (Broadcast-KE), wherein the traffic information which is broadcast may comprise traffic flow information, traffic control information, sudden incident information, road condition information, and weather information and the like.

In more particular, the traffic flow information may comprise road position information (LinkID), speed information (Speed Rate), travel time information (TravelTime) and the like, the traffic control information may comprise event position information (Location Information), event type (EventTypeCode) and the like, the sudden incident information may comprise sudden incident type (IncidentTypeCode), sudden incident start point (BeginID), sudden incident end point (EndID) and the like, the road condition information may comprise road position information (LinkID), road surface condition information (SurfaceConditionCode) and the like, the weather information may comprise a weather report (wind speed, humidity, precipitation ratio and the like), weather forecast (precipitation probability, wind speed and the like), weather alert (region, alarm type, etc.) and the like.

And, the processing unit 220 of the on-board equipment 200 extracts detail traffic information from the traffic information received from the second communication unit 210 (S30).

Here, the detail traffic information may include a message creating time (Message Creative Generalized Time, MCGT), a node link (LinkID (road information, position information)), speed information (SpeedRate) of the node link, traffic volume information (VolumeRate) of the node link, and density information (DensityRate) of the node link and the like among the traffic flow information broadcast from the road-side equipment 100.

If the detail traffic information is extracted in step S30, the second converting unit 230 of the on-board equipment 200 encodes the detail traffic information extracted in step S30 and sends the encoded detail traffic information to the first converting unit 310 (S40).

In other words, the detail traffic information extracted by the processing unit 220 can be encoded and sent in a suitable form (e.g., RS-232) by the interface between the on-board equipment 200 and the communication terminal 300 for a vehicle.

The first converting unit 310 can receive and decode the detail traffic information encoded in step S40 (S50).

And then, the communication control unit 320 receives the detail traffic information decoded in step S50, and set a communication configuration to correspond to the detail traffic information received referring to a data storing unit 330.

To this end, the communication control unit 320 decides whether there is a traffic congestion step corresponding to the detail traffic information referring to the data storing unit 330 where the setting values are stored which define access trying windows (Contention Window, CW) and transmit powers (Tx Power) corresponding to the traffic congestion steps classified based on a traffic volume, a density and a speed per a node link (S60).

To this end, the setting values corresponding to the traffic congestion steps which are stored in the data storing unit 330 can be defined as follows:

At first, the traffic congestion steps can be classified based on a traffic volume, a density, and a speed stepwise per a node link, and for example, a traffic volume for a national road can be classified into 1 step (300 vehicles/hour or less), 2 step (500 vehicles/hour or less), 3 step (700 vehicles/hour or less), 4 step (900 vehicles/hour or less), 5 step (1100 vehicles/hour or more), and 6 step (1300 vehicles/hour or more), based on 700 vehicles/hour (referring to a traffic volume average, 2013), and classified into 1 step (100 vehicles or less), 2 step (200 vehicles or less), and 3 step (400 vehicles or more), assuming that for the national road with a 4-lane round-trip of 500 m intervals where a speed limit is 80 km/h, a density is up to 400 vehicles, and the speeds in these conditions are classified into 1 step (35 km/h or less), 2 step (55 km/h or less), and 3 step (75 km/h or more).

The setting values corresponding to these traffic congestion steps can be defined as follows:
setting value: CW=7, Tx Power=level 6, corresponding to traffic volume 1 step, density 1 step, speed 3 step;
setting value: CW=15, Tx Power=level 5, corresponding to traffic volume 2 step, density 1 step, speed 2, 3 step;
setting value: CW=31, Tx Power=level 4, corresponding to traffic volume 3 step, density 2 step, speed 2, 3 step;
setting value: CW=63, Tx Power=level 3, corresponding to traffic volume 4 step, density 2 step, speed 2 step;
setting value: CW=127, Tx Power=level 2, corresponding to traffic volume 5 step, density 3 step, speed 1, 2 step; and
setting value: CW=255, Tx Power=level 1, corresponding to traffic volume 6 step, density 3 step, speed 1, 2 step.

The above values are provided as only an example to aid the understanding of the present invention, and are not intended to limit the traffic congestion steps and setting values of the present invention to the above-mentioned numerical values.

As a result of deciding in S60 step, if a traffic congestion step corresponding to the detail traffic information decided is stored in the data storing unit 330, the communication configuration is set to a setting value corresponding to the traffic congestion step decided (S70).

If there is no traffic congestion step corresponding to the detail traffic information decided, the communication configuration can be set to a default value (S71).

Here, the communication terminal 300 may comprise not only a communication (V2X) apparatus for a vehicle and but also the dedicated short range communication (DSRC) system.

The first communication unit 340 may adjust the communication configuration as set in the communication control unit 320 and then perform the communication.

As mentioned above, the method for setting the communication configuration of the communication terminal for a vehicle according to an embodiment of the present invention can recognize surrounding circumstances using the traffic information system based on the Dedicated Short Range Communication (DSRC), and adjust the communication configuration of the communication terminal based on the recognized information to improve efficiency of its communication performance.

While the present invention have been described with reference to embodiments shown in the drawings, the present invention is described only for illustration and are not limited to the embodiments described herein. It will be thus appreciated by the skilled person in the art that various variants or modifications may be made without departing from the scope and spirit of the invention. Therefore, the scope of the present invention should be defined only in accordance with the following claims and their equivalents.

What is claimed is:

1. A communication terminal for a vehicle, comprising:
a first converting unit for receiving and decoding encoded detail traffic information from an on-board equipment, the on-board equipment receiving traffic information from a road-side equipment (RSE) and extracting detail traffic information for the traffic information;
a communication control unit for receiving the decoded detail traffic information from the first converting unit and setting a communication configuration corresponding to the detail traffic information referring to a data storing unit; and
a first communication unit for communicating under the communication configuration set by the communication control unit.

2. The communication terminal for a vehicle of claim 1, wherein the on-board equipment receives the traffic information from the road-side equipment via a dedicated short range communication (DSRC) through a second communication unit; receives the traffic information from the second communication unit and extracts the detail traffic information from the traffic information through a processing unit; and encodes detail traffic information extracted by the processing unit and transmits the encoded detail traffic information through a second converting unit.

3. The communication terminal for a vehicle of claim 2, wherein the processing unit extracts the detail traffic information comprising a node link, a traffic volume, a density and a speed from the traffic information received from the second communication unit.

4. The communication terminal for a vehicle of claim 1, further comprising:
a data storing unit where the setting values are stored which define access trying windows (CW) and transmit powers (Tx Power) corresponding to the traffic congestion steps classified based on a traffic volume, a density and a speed per a node link.

5. The communication terminal for a vehicle of claim 1, wherein the communication control unit sets the communication configuration to a setting value according to the traffic congestion step corresponding to the detail traffic information.

6. A method of setting a communication configuration of a communication terminal for a vehicle, comprising:
determining, by an on-board equipment, whether a vehicle enters a dedicated short range communication (DSRC) area;
when the vehicle entered the dedicated short range communication area, receiving, by the on-board equipment, traffic information from a road-side equipment via the dedicated short range communication;
receiving, by the on-board equipment, the traffic information and extracting detail traffic information from the traffic information;
encoding, by the on-board equipment, the extracted detail traffic information, and transmitting the encoded detail traffic information to a first converting unit;
receiving and decoding, by the first converting unit, the encoded detail traffic information; and
receiving, by a communication control unit, the decoded detail traffic information and setting the communication configuration to correspond to the detail traffic information referring to a data storing unit.

7. The method of claim 6, wherein extracting the detail traffic information comprises:
extracting the detail traffic information comprising a node link, a traffic volume, a density and a speed from the traffic information received from a second communication unit of the on-board equipment.

8. The method of claim 6, wherein the data storing unit stores setting values which define access trying windows (CW) and transmit powers (Tx Power) corresponding to the traffic congestion steps classified based on a traffic volume, a density and a speed per a node link.

9. The method of claim 8, wherein the communication control unit sets the communication configuration to the setting values according to the traffic congestion step corresponding to the detail traffic information.
